(19) United States
(12) Patent Application Publication
(10) Pub. No.: US 2025/0008917 A1
(43) Pub. Date: Jan. 9, 2025

(54) ABSORBENT AND BIODEGRADABLE MATERIAL

(71) Applicants: Brice Patrick MURPHY, Round Rock, TX (US); Brent MURPHY, Aurora, CO (US); Kent MURPHY, Arlington, VA (US)

(72) Inventors: Brice Patrick MURPHY, Round Rock, TX (US); Brent MURPHY, Aurora, CO (US); Kent MURPHY, Arlington, VA (US)

(21) Appl. No.: 18/891,967

(22) Filed: Sep. 20, 2024

Related U.S. Application Data
(63) Continuation-in-part of application No. 18/219,476, filed on Jul. 7, 2023.
(60) Provisional application No. 63/388,227, filed on Jul. 11, 2022.

(51) Int. Cl. A01K 1/015; A01K 1/01

(52) U.S. Cl. CPC A01K 1/0155; A01K 1/0114

(57) ABSTRACT

An absorbent material suitable for cat litter among other things may include glucomannan of a known purity and biodegradable and/or non-biodegradable additives/base material.

### CROSS-REFERENCES TO RELATED APPLICATIONS

This application is a continuation-in-part of U.S. patent application Ser. No. 18/219,476, filed Jul. 7, 2023, which claims the benefit of U.S. Provisional Patent Application No. 63/388,227, filed Jul. 11, 2022, the entire contents of both of which are herein incorporated by reference.

### STATEMENT REGARDING FEDERALLY SPONSORED RESEARCH OR DEVELOPMENT

(NOT APPLICABLE)

### BACKGROUND

The embodiments described herein relate generally to absorbent materials and, more particularly, to an absorbent and biodegradable material designed to absorb substances in solid, liquid, gas, or combination phases.

Numerous products require the need for absorbent materials. Exemplary products include cat litter, diapers, hospital solidifiers, and the like. The largest selling and most effective absorbent material is sodium polyacrylate, which is not biodegradable. Another frequently used material is clay, which must be mined. Each of these materials is filling landfills.

Therefore, there is a need for a material that is both absorbent and biodegradable to provide for absorbing substances in all phases without continuing to fill landfills.

Conventional clay-based cat litter is typically made of granules of smectite, typically smectite or swelling clay(s), like bentonite clay(s), which frequently includes other components like calcium carbonate, silica, fragrances or scents, and odor controllers. While many attempts have been made in the past to produce lighter weight clay-based litter having bulk densities less than 40 pounds per cubic feet, these attempts have had limited success. Quite often litter performance is either adversely impacted or the weight reduction is not all that significant.

Attempts to produce lighter weight clay-based litter by adding lighter weight components have been limited by the fact that such litters still require at least 70% swelling clays, typically bentonite, to still perform adequately as litter.

Glucomannan is a hydrophilic polysaccharide found as a hemicellulose component present in the cell walls of certain plant species. Glucomannan acts as a hydrocolloid in solution, with an unusually high molecular weight of 1.9×10⁶ g/mol, it is capable of absorbing as much as 50 times its mass in water. The effectiveness of this reaction is dependent on the ratio of D-mannose to D-glucose monomers, as well as the degree of acetylation. Mannose, being an epimer of glucose contains a hydroxyl group situated to the left of its second carbon atom as opposed to the right; this inversion of the C-2 chiral center leads to differing biochemistry within the hydration shells and is thought to facilitate covalence and improve hydrogen bonding with water, as opposed to the orientation of mannose. Although different sources of glucomannan have a wide range of mannose/glucose molar ratios, commercially available glucomannan derived from the roots of the konjac plant typically has a mannose/glucose molar ratio of about 1.6:1 with a polymer acetylation of 5-10%. While glucomannan is derived from a multitude of sources, the increasing popularity of konjac root in culinary and dietary applications provides a price point and availability advantage over other less common sources.

Glucomannan is present in some quantity in most plants as it provides a drought tolerant means of storing water and energy needed for photosynthesis. However, it is found in larger quantities in some species of orchids, succulents, non-deciduous softwood trees, as well as the cell walls of certain fungi. Common sources include O. salep, a rare and protected orchid native to the northern-eastern Mediterranean coast; P. coniferophyta, a division of plants containing most species of pine; A. aspergillus, one of the most common types of mold on earth; as well as A. araceae, a tuberous family of flowering plants also known as Arums containing some 4000 known species including A. konjac, A. bulbifer and A. titanum, all of which are commercially cultivated for glucomannan production. Konjac, as well as other Arums are perennial, they possess a large root or “corm” which allows them to enter a state of dormancy in winter, and commence their growth in spring. This corm is where the largest concentration of glucomannan can be found, as it allows the plant to retain water through drought or dormancy. In nature, konjac roots are comprised of about 40% glucomannan by volume with the concentration increasing towards the center of the corm. It is increasingly speculated however, that konjac responds negatively to modern farming practices, resulting in concentrations of as low as 5%.

Glucomannan found within the corms of the konjac plant, as well as other members of the Arum family can be separated from the plant matter relatively easily, as the size and density of the glucomannan particles are much larger than that of the surrounding starch. Traditionally, a process of slicing and drying the corms in the sun has been used followed by a dry milling similar to wheat flour and other grains. The resulting powder is then sifted through a varying set of screens to separate larger glucomannan particles from smaller flour and starch. A more modernized method involves the submersion of whole corms in a buffer solution containing an anti-swelling agent as well as other additives to reduce browning prior to the grinding and milling stage. The resulting slurry is then screened and dried, to be further separated through “air classification” where the lighter starch particles are blown away from heavier glucomannan particles. This modern method produces glucomannan with a purity of about 90%, compared to 50-75% purity through the traditional “dry milling” technique.

As the popularity of konjac glucomannan has increased, so has research and regulation surrounding its production and use. In Japan, the cultivation methods of farming konjac are classified into two categories; namely, the modern farming techniques utilized by large scale operations such as row farming, the separation of corms by age, and the application of synthetic pesticides and fertilizers are referred to as “Uedama,” while small family-owned farms utilizing practices essentially unchanged for over 1000 years are known as “Jinenjo.” The philosophy of “Jinenjo” style farming is to embrace the habitat in which the plant grows naturally, and to nurture and facilitate a synergistic ecosystem surrounding the fields in which a crop is grown.

Traditional “Jinenjo” farming techniques include planting fields along sloping hillsides, fertilizing fields with local herbs and berries, as well as allowing fully grown corms and rhizomatic offsets to exist in fields together. The use of these techniques allows farmers to continually cultivate within a single field without the need for crop rotation for over 100 years. Testing of crops in certain Asian markets has shown that the implementation of modern “Uedama” techniques has increased the yield of corms per hectare by 300% compared to traditional techniques, while the glucomannan content of the corms has dropped to as little as 5% compared to around 40% with traditional “Jinenjo” farming methods. That is to say, processing of 10 tonnes of material grown with traditional methods would result in 4 tonnes of glucomannan, as opposed to only ½ tonne from corms grown by modern means.

Viscosity is the accepted industry standard used to determine the purity of glucomannan as well as the mannose/glucose ratio. Testing of glucomannan from modern “Uedama” farms showed a lower viscosity at the same purity, suggesting a higher mannose to glucose ratio compared to traditional “Jinenjo” farms which would result in a lessened ability to absorb water/liquids. Extensive research has been conducted at Tottori University in Japan on the farming techniques used to cultivate the konjac root, where a hybridized farming method is being developed that incorporates beneficial aspects of both Jinenjo and Uedama techniques to merge tradition with modern science in the hopes of producing the best quality product possible. Faculty from the University have worked with local farmers to implement this revolutionary technique as well as develop co-ops, particularly in the Gunma prefecture of the Kanto region of Japan where over 80% of all domestically produced konjac is grown, as well as Kochi in the Shikoku Region and along the southern coast of Chugoku, as these areas all share a similar climate, latitude and southeast facing slopes with where the konjac plant can be found naturally. The Japanese government has very stringent testing and regulatory standards regarding the sale and export of konjac glucomannan, including a grading system based in part on viscosity, as well as mandatory testing for no less than 30% of all product sold. In summary, the best source of konjac glucomannan would be Gunma or Kochi, with the greater majority of product being produced in Gunma which is also thought to be of the highest quality in the global market.

### SUMMARY

Some embodiments of the present disclosure include an absorbent and biodegradable material. The material may include glucomannan and biodegradable and/or non-biodegradable additives. The biodegradable additives may be corn, walnut shells, newspaper, grass, wood chips, and the like.

In an exemplary embodiment, an absorbent material includes 1-99% by weight glucomannan having a known purity, and at least one of biodegradable and non-biodegradable additives. The known purity of the glucomannan may be less than 100%, or may be 1-99%, or may be 75-99%, or may be 75-90%, or may be one of 75% and 90%, or may be 75%.

The material may include 5-25% by weight of the glucomannan and 75-95% by weight of the biodegradable additives. The biodegradable and non-biodegradable additives may be selected from clay or bentonite, or may be commercially available cat litter, or may be commercially available clumping and non-clumping silica cat litter, or may be commercially available organic cat litter.

A particle size of the glucomannan may range from 4 μm-2 mm, or from 50 μm-0.3 mm, or from 50-150 μm.

In another exemplary embodiment, cat litter may include a base material that is organic or inorganic, and 1-99% by weight glucomannan of a known purity. The cat litter is suitable for use in a known litter robot.

In yet another exemplary embodiment, a method of manufacturing a composition for absorbing fluids includes the steps of mixing a base material that is organic or inorganic with 1-99% by weight glucomannan of a known purity. The method may include, prior to the mixing step, heating the glucomannan.

### BRIEF DESCRIPTION OF THE DRAWINGS

These and other aspects and advantages will be described in detail with reference to the accompanying drawings, in which:

FIG. 1 shows test results in a composition using glucomannan with clay;

FIG. 2 shows test results in a composition using glucomannan with walnut shells;

FIG. 3 shows test results in a composition using glucomannan with wheat;

FIGS. 4 and 5 show test results using cat urine in a composition using glucomannan with clay;

FIG. 6 shows performance data based on glucomannan purity;

FIG. 7 compares the cost of glucomannan in different purities;

FIGS. 8-14 show examples of 90% pure glucomannan added to different litters from 0-100%;

FIGS. 15-17 show results from actual cats using two litter boxes;

FIGS. 18-22 show results from experiments conducted regarding percentage of glucomannan mixed with “off the shelf” cat litters as a base material; and

FIGS. 23-25 show an exemplary application to a litter robot.

### DETAILED DESCRIPTION

In the following detailed description, numerous details, examples, and embodiments of the invention are described. However, it will be clear and apparent to those skilled in the art that the invention is not limited to the embodiments set forth and that the invention can be adapted for any of several applications.

The composition of the present disclosure may be used as an absorbent material and may comprise the elements described below. This list of possible constituent elements is intended to be exemplary only, and it is not intended that this list be used to limit the composition of the present application to just these elements. Persons having ordinary skill in the art relevant to the present disclosure may understand there to be equivalent elements that may be substituted within the present disclosure without changing the essential function or operation of the composition.

The various elements of the composition of the described embodiments may be related in the described exemplary fashion. It is not intended to limit the scope or nature of the relationships between the various elements and the following examples are presented as illustrative examples only.

By way of example, some embodiments include an absorbent and biodegradable material comprising glucomannan and a base material or additives, wherein the base material/additives are also biodegradable and may include, for example, corn (cob), walnut shells, newspaper, grass, wood chips, cedar pine, corn pulp, and the like. The additives may also include inorganic materials, such as sodium polyacrylate. In some embodiments, the material may also include non-biodegradable additives. In yet further embodiments, the additives may also include fragrances, odor reducers, ammonia neutralizers, and others. Another exemplary base material/additive is DDG (dried distiller grains) or x-DDG. DDGs are leftovers after corn kernels are used to produce ethanol, and x-DDGs are DDGs that, after being used for ethanol production, are treated with one or more solvents to extract any potentially useful natural compounds that remain. In embodiments, the material may be designed to absorb substances in solid, liquid, gas, or combination phases.

The additives may be added to the material for a variety of purposes, which may be specific to the application of the material. For example, the additives may be added for the following purposes: non-stick, clumping, neutralizing smell, being flushable in public sewage or in a septic tank, compostable, or as a fertilizer.

In embodiments, the material may comprise from about 1 to about 99% by weight glucomannan. More specifically, a particular embodiment may comprise about 75 to about 95% by weight additive and about 5 to about 25% by weight glucomannan.

Glucomannan is made from the konjac plant, is biodegradable, and can absorb up to 50 times its weight. For example, when used in a cat litter, 10 grams of glucomannan may absorb 1.5 ounces of liquid. In contrast, an existing clay cat litter requires 100 grams of clay to absorb 1.5 ounces of liquid. As such, glucomannan is a more effective absorbent than clay, and it is biodegradable, unlike clay. This is supported by the data from the following examples.

Example 1 (Walnut Shells and Glucomannan): To show improvements over existing organic cat litter, the absorbent properties of a composition were tested. First, 100% organic walnut shells were tested. An amount of 44 grams/1.55 oz. of water simulating one cat urinating was poured onto the walnut shells, and clumping behavior was observed. Specifically, it was noted what amount of walnut shells was required (in grams) to remove the 44 grams of water. Then, compositions with different percentages of glucomannan with the walnut shells were created. Specifically, the compositions included 90% walnut shells and 10% glucomannan, 75% walnut shells and 25% glucomannan, 50% walnut shells and 50% glucomannan, and 100% glucomannan.

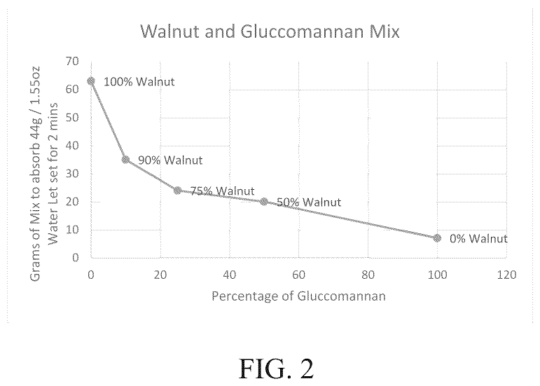

It was observed that 100% walnut shells resulted in very poor clumping, and 63 g of the material was required to remove the 44 g of water. The walnut shells also stuck to the container. It was also observed that 100% glucomannan only required 7 g of the glucomannan to remove the 44g of water and provide a perfect clump, which was easily removed all in one piece from the container without sticking to the sides of the container. When the composition included 10% glucomannan and 90% walnut shells, 35 g of the material was required to remove the 44 g of water. Again, the material was easily removed in one perfect clump with no sticking to the container, and the water never penetrated the material more than a few millimeters. The data is presented in FIG. 2 and shown below in Table 1:

| | | | Grams of mix to absorb |
|---|---|---|---|
| | | | 44 g/1.55 oz |
| | Walnut | Glucomannan | water let set for 2 mins |
| 100% Walnut | 100 | 0 | 63 |
| 90% Walnut | 90 | 10 | 35 |
| 75% Walnut | 75 | 25 | 24 |
| 50% Walnut | 50 | 50 | 20 |
| 0% Walnut | 0 | 100 | 7 |

As such, by adding glucomannan to the material, the amount of walnut shells could be reduced dramatically, reducing overall weight of the material while still providing a perfect clump and while keeping the container holding the material clean. In fact, at 90% walnut shells and 10% glucomannan, the mixture was almost twice as effective as walnut shells alone.

Example 2 (Clay and Glucomannan): The absorbent properties of a composition were tested. First, 100% clay was tested. The same amount of 44 grams/1.55 oz. of water simulating one cat urinating was poured onto the clay, and clumping behavior was observed. Specifically, it was noted what amount of clay was required (in grams) to remove the 44 grams of water. Then, compositions with different percentages of glucomannan with the clay were created. Specifically, the compositions included 90% clay and 10% glucomannan, 75% clay and 25% glucomannan, and 100% glucomannan.

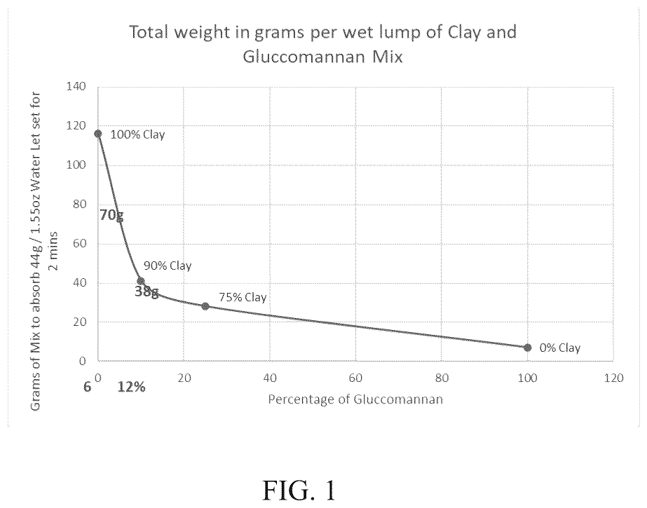

It was observed that 100% clay resulted in very poor clumping, and 116 g of the material was required to remove the 44 g of water. It was also observed that 100% glucomannan only required 7 g of the glucomannan to remove the 44g of water and provide a perfect clump, which was easily removed all in one piece from the container without sticking to the sides of the container. When the composition included 10% glucomannan and 90% clay, 41 g of the material was required to remove the 44 g of water. The data is presented in FIG. 1 and shown below in Table 2:

| | | | Grams of mix to absorb |
|---|---|---|---|
| | | | 44 g/1.55 oz |
| | Clay | Glucomannan | water let set for 2 mins |
| 100% Clay | 100 | 0 | 116 |
| 90% Clay | 90 | 10 | 41 |
| 75% Clay | 75 | 25 | 28 |
| 0% Clay | 0 | 100 | 7 |

By adding glucomannan to the material, the amount of clay could be reduced dramatically, reducing overall weight of the material while still providing a perfect clump and while keeping the container holding the material clean. In fact, at 90% clay and 10% glucomannan, the mixture was more than twice as effective as clay alone.

With continued reference to FIG. 1, the test results show a much greater effect of the glucomannan in the lower percentages by weight. That is, from the test results shown in FIG. 1, it appears that an optimum composition may include between 6-12% of glucomannan by weight mixed with clay. At 6%, 70 g of clay were required to absorb the 44 g of water, resulting in 42% savings of clay. With 12% glucomannan added in the composition, 38 g of clay were required to absorb the 44 g of water, resulting in 68% savings of clay.

Still additional advantageous results were observed with the use of glucomannan in the 6-12% by weight range. For example, it was observed that the resulting clumps were smaller and flatter and closer to the surface for easy removal. Additionally, the cat urine did not reach the bottom of the litter box, thus avoiding additional mess requiring cleaning. The clumps also can be readily disposed of in a personal compost or flushed.

Example 3 (Wheat and Glucomannan): The absorbent properties of a composition were tested. First, 100% wheat was tested. The same amount of 44 grams/1.55 oz. of water simulating one cat urinating was poured onto the wheat, and clumping behavior was observed. Specifically, it was noted what amount of wheat was required (in grams) to remove the 44 grams of water. Then, compositions with different percentages of glucomannan with the wheat were created. Specifically, the compositions included 90% wheat and 10% glucomannan, 75% wheat and 25% glucomannan, 50% wheat and 50% glucomannan, and 100% glucomannan.

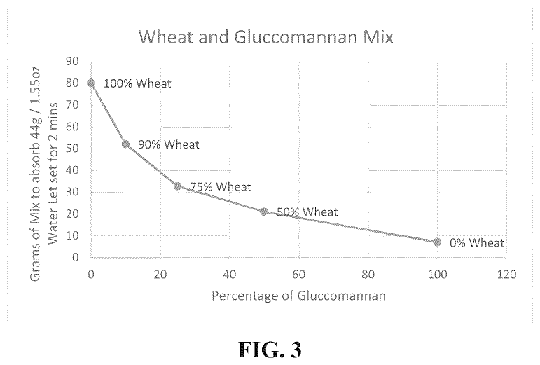

It was observed that 100% wheat resulted in very poor clumping, and 80 g of the material was required to remove the 44 g of water. It was also observed that 100% glucomannan only required 7 g of the glucomannan to remove the 44g of water and provide a perfect clump, which was easily removed all in one piece from the container without sticking to the sides of the container. When the composition included 10% glucomannan and 90% wheat, 52 g of the material was required to remove the 44 g of water. The data is presented in FIG. 3 and shown below in Table 3:

| | | | Grams of mix to absorb |
|---|---|---|---|
| | | | 44 g/1.55 oz |
| | Wheat | Glucomannan | water let set for 2 mins |
| 100% Wheat | 100 | 0 | 80 |
| 90% Wheat | 90 | 10 | 52 |
| 75% Wheat | 75 | 25 | 32.7 |
| 50% Wheat | 50 | 50 | 21 |
| 0% Wheat | 0 | 100 | 7 |

By adding glucomannan to the material, the amount of wheat could be reduced dramatically, reducing overall weight of the material while still providing a perfect clump and while keeping the container holding the material clean. In fact, at 75% wheat and 25% glucomannan, the mixture was more than twice as effective as wheat alone.

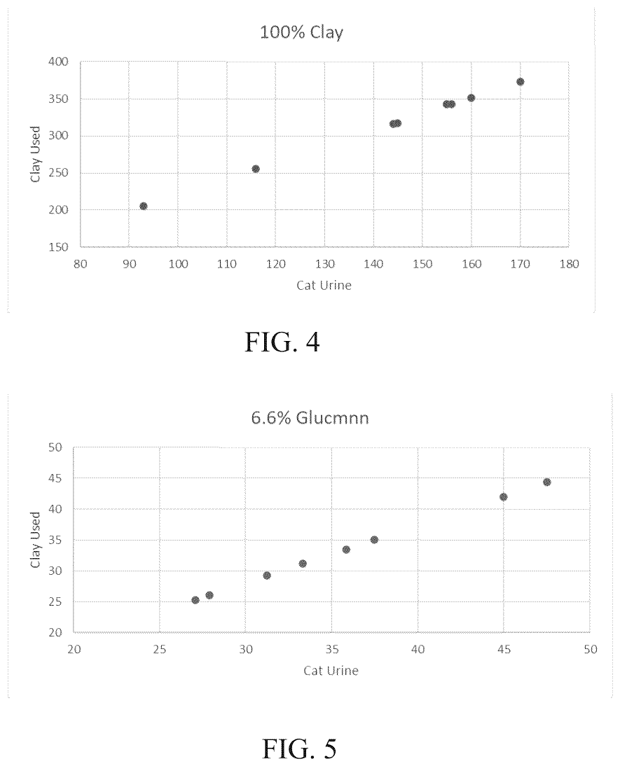

FIGS. 4 and 5 show test results using cat urine instead of water. The results generally align with those from the tests using water. FIG. 4 documents eight days of cat urine, where two cats averaged 3.75 urinations per day versus the weight of clay used to absorb the urinations with a 100% clay composition. The results show 83.3 g of 100% clay needed to absorb 1 cat urination. FIG. 5 shows the amount of clay and 6.6% glucomannan used to process eight cat urination clumps. With the composition including 6.6% glucomannan, 49 g of clay were required to absorb each cat urination, resulting in about 41% clay savings.

Glucomannan may be in the form of a powder that can be mixed or blended with a selected material (e.g., clay, walnut shells, wheat, etc. as discussed above).

Glucomannan is soluble in water, and in some embodiments, a glucomannan “spray” can be derived and sprayed directly on existing cat litter products. It has been discovered that the treated cat litter provides better absorbency and utilizes less clay or other cat litter base material for effective clump formation.

In another exemplary application, a fabric material infused with glucomannan can be added at the bottom of the litter box to prevent cat urine on existing cat litter to reach the bottom of the letter box.

To manufacture the material of the present disclosure, glucomannan would be mixed with the additives at a percentage that may vary depending on the additives used and the end use of the material. The composition can include the base material (e.g., clay, corn, wheat, etc.) and formed into pellets, or in powder. In some embodiments, the glucomannan may be mixed before or after the pellets are made. Pellets can be made using known pellet-making machinery. The product can be packaged for customers to mix themselves with an existing absorbent (e.g., cat litter). Glucomannan could also be put into a solution to be then coated on the base material.

Any known manufacturing methods may be utilized to arrive at the described composition of materials. Exemplary methods are described in U.S. Pat. No. 11,457,605, U.S. Pat. No. 9,266,089, Spanish patent ES2808666T3, Chinese patent CN109329078B, Chinese patent CN104837337B, and U.S. Pat. No. 10,470,433, the contents of which are hereby incorporated by reference.

In respect of density and mesh size, exemplary suitable parameters are described in PCT International Publication WO1998054956A1, the contents of which are hereby incorporated by reference.

The material may be used to absorb, for example, water, oil, gas, blood, bodily fluids, urine, hazardous waste, hazardous materials, moisture in air, other volatiles in the air, feces, and the like. The absorbent material may then be used in various applications, including as a hospital grade solidifier, cat litter, diaper material, with buried cables, in above ground storage tanks, in bedpans, to treat oil spills, as rodent bedding, as chicken/livestock bedding, in zoo applications, in farming applications, in compost toilets for campers and RV vans, and the like.

In the case of diapers and bedpans, the material may function to absorb urine and feces while reducing odor. For cat litter, the material may absorb urine and feces in litter boxes or the like, while helping to attract cats to the litter box and reduce odor. With respect to being a hospital waste solidifier, the material may be a powder that can turn liquid medical waste into a gel-like substance while reducing odor. When used in buried cables and above ground storage tanks, the material may absorb unwanted liquids. In some embodiments, the material may be designed to be added to an existing absorbent, such as cat litter, or it may be designed to be used alone as an absorbent.

Experiments were conducted regarding glucomannan purity in terms of percentage several times in a consistent manner, and with consistent results. Having compared glucomannan samples obtained from a variety of vendors, purity levels of 100%, 95%, 90% and 75% were selected as they are common purity levels found as a standard in the industry. A “konjac flour” was also tested, with the product claiming to be an unaltered konjac root, ground to a flour, as well as a sample of sliced and dried konjac root which was ground and milled at the time of the experiment. The “konjac flour” selected was thought to be of a similar glucomannan content to a whole corm, somewhere in the range of about 40%; however, the data collected would suggest a purity much lower (5% or less). Further processing in a later experiment revealed a purity of around 3%, which supports the aforementioned theory of modern farming techniques greatly reducing the glucomannan content of whole corms. The sliced and dried konjac chips were ground and processed in a method similar to the “wet processing” technique outlined above, and revealed a glucomannan purity of about 20-25%. A plotting of the data collected on varying purities of glucomannan revealed a curve similar to that of the percentage mix experiments, suggesting that the varying levels of impurity within the glucomannan itself behave in much the same way as the portion of mass made up by the cat litter used as a base in those experiments. This would imply that any sort of medium used as an aggregate in a glucomannan based cat litter would perform essentially the same, merely providing additional mass to the glucomannan clump with an ideal cost-to-effectiveness ratio falling somewhere along the curve.

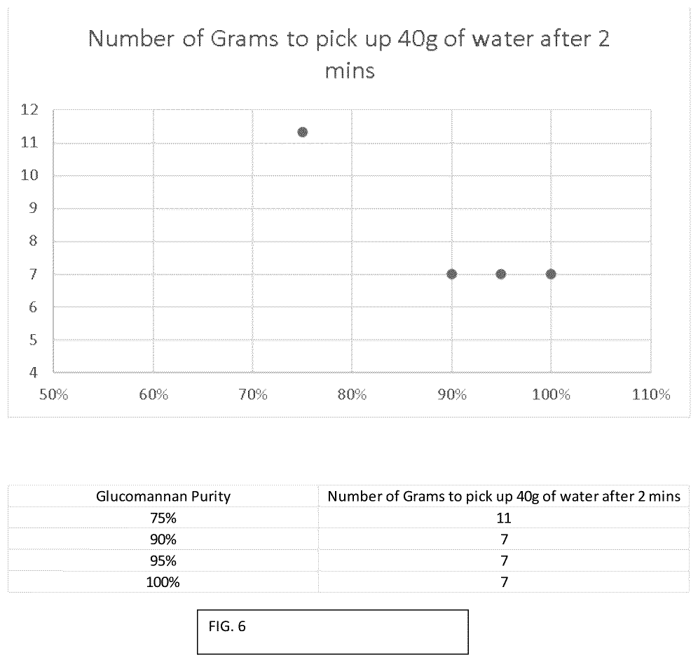

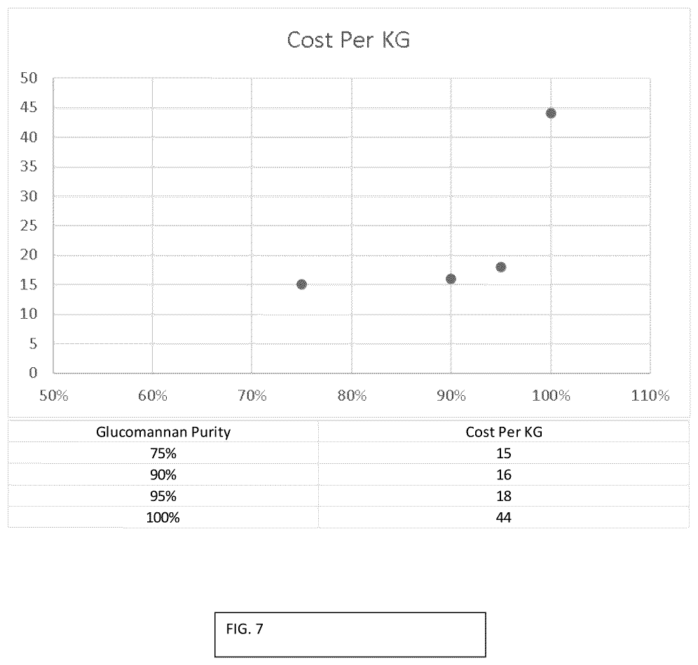

There is little data comparing performance characteristics of glucomannan with different purities, specifically water absorption and cat urine absorption. FIG. 6 shows performance data based on glucomannan purity. FIG. 7 compares the cost of glucomannan in different purities. As shown, in a mix using glucomannan with 75% purity, the mixture required only about 11 g of glucomannan to absorb 40 g of water after two minutes. This data was taken using 40 g of water (simulating one cat urination), waiting two minutes and picking the clump out, and weighing the amount of glucomannan required to absorb it and pick it up. For 90% pure glucomannan, 40 g of water was absorbed using only 7 g of glucomannan. Three data points for each purity were done by two different people eight months apart. Water was observed being absorbed at a faster rate at the lower purities-for example, 90% pure absorbs faster than 100% pure, and 75% absorbs faster that 90% pure. This result could be used to help prevent urine from running to the edge of the box as it absorbs slowly across the top of the litter.

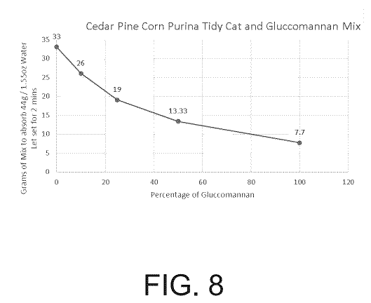

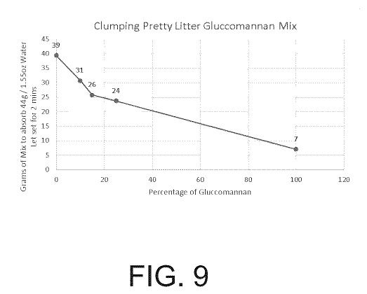

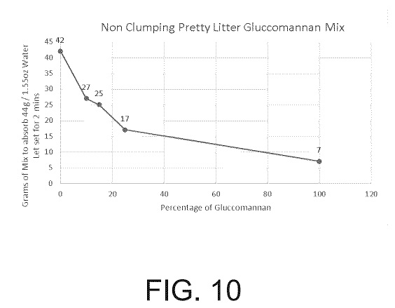

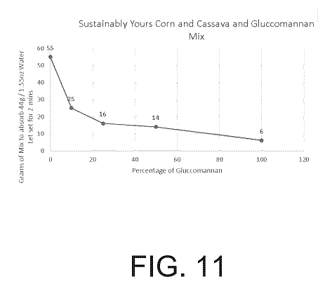

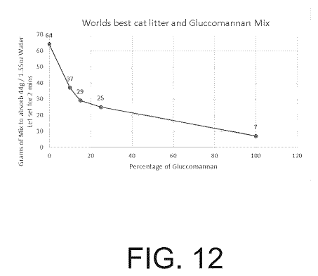

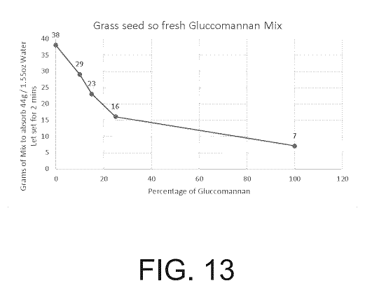

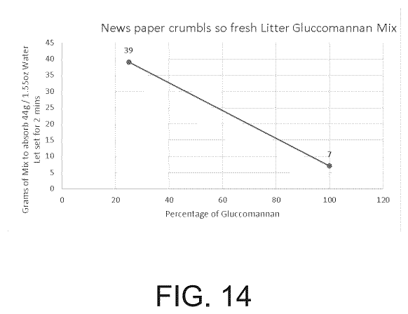

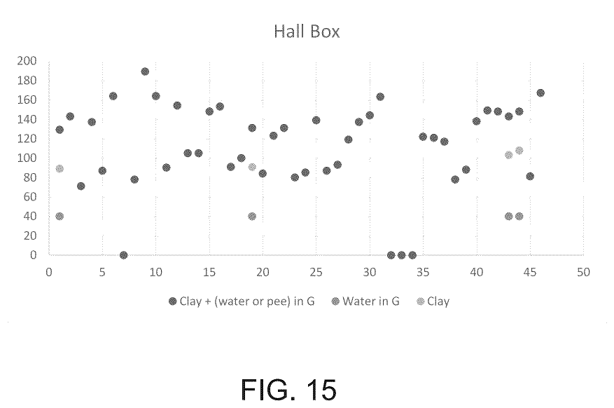

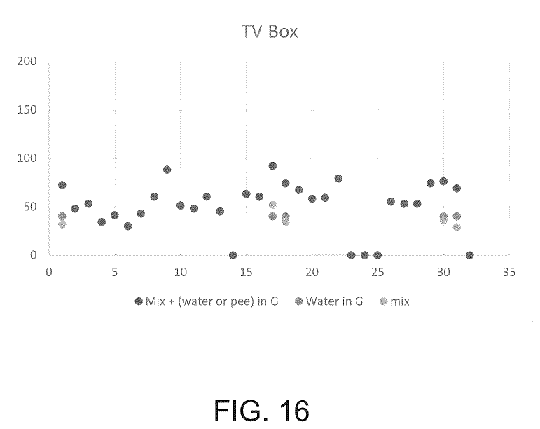

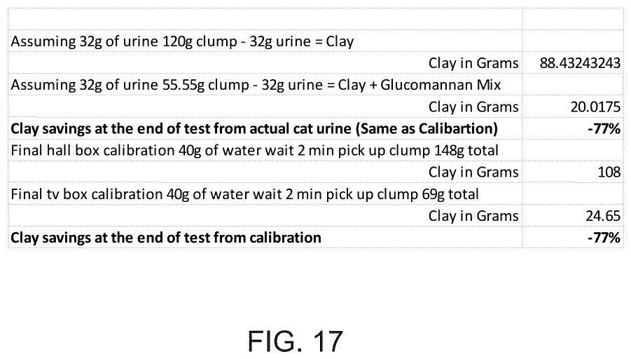

FIGS. 8-14 are examples of 90% pure glucomannan added to different litters from 0-100%. Clay, organics, and silica litters were demonstrated. FIGS. 15-17 show results from actual cats using two litter boxes comparing 100% clay in one and 85% clay/15% glucomannan (90% pure) showing 77% savings in clay usage.

It was discovered that 100% pure glucomannan does not absorb water immediately, sometimes causing the water or cat urine to run to the edge of the box creating a mess. The absorption was faster with the lower percentage purity glucomannan, with 75% being the fastest. It was also discovered that the higher percentages including 90%, 95%, 100% are chemically processed versus the lower percentage of 75%, which is dry processed. When comparing containers of each of the four samples, the higher percentages look pure and bleached white and the 75% purity glucomannan has a different feel and a slightly yellow color.

The product selected for use in the following experiments based on cost, availability and performance was the glucomannan of a 90% purity, this product has presented consistent results through some months of testing with multiple batches acquired from the same vendor. The data collected shows a consistent clump size of 7 g to pick up 40 g of water through multiple experiments with very little, if any variance at all; and is therefore considered a constant throughout the following experiments.

The experiments conducted regarding percentage of glucomannan mixed with “off the shelf” cat litters as a base material have been conducted in a consistent manner, with the method being outlined as such:
1. 400 grams of starting material were prepared in a pyrex dish approx. 7″×7″ square, this provided an average depth of about 1.5″ of litter.
2. Experiments containing glucomannan were mixed in a consistent manner, being stirred and poured between two bowls to ensure thorough coating of the base litter, as well as an even mixture.
3. 40 grams of water were administered to the center of the mixture within the dish over the course of about 8 seconds.
4. The water was left to clump for a time of 2 minutes.
5. The clump was then removed without agitation and weighed promptly.
6. Steps 3-5 were repeated three times for each experiment.

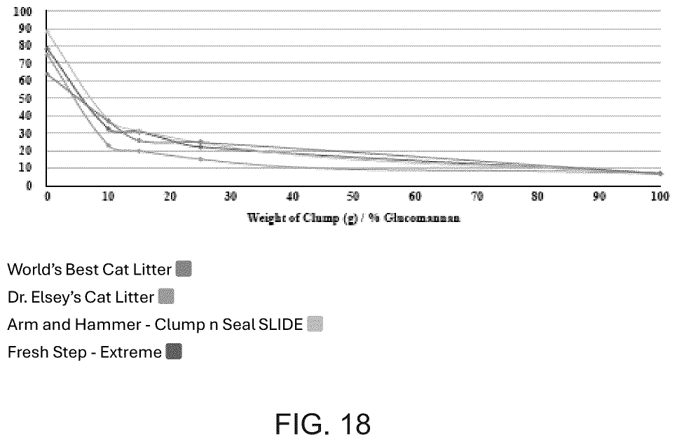

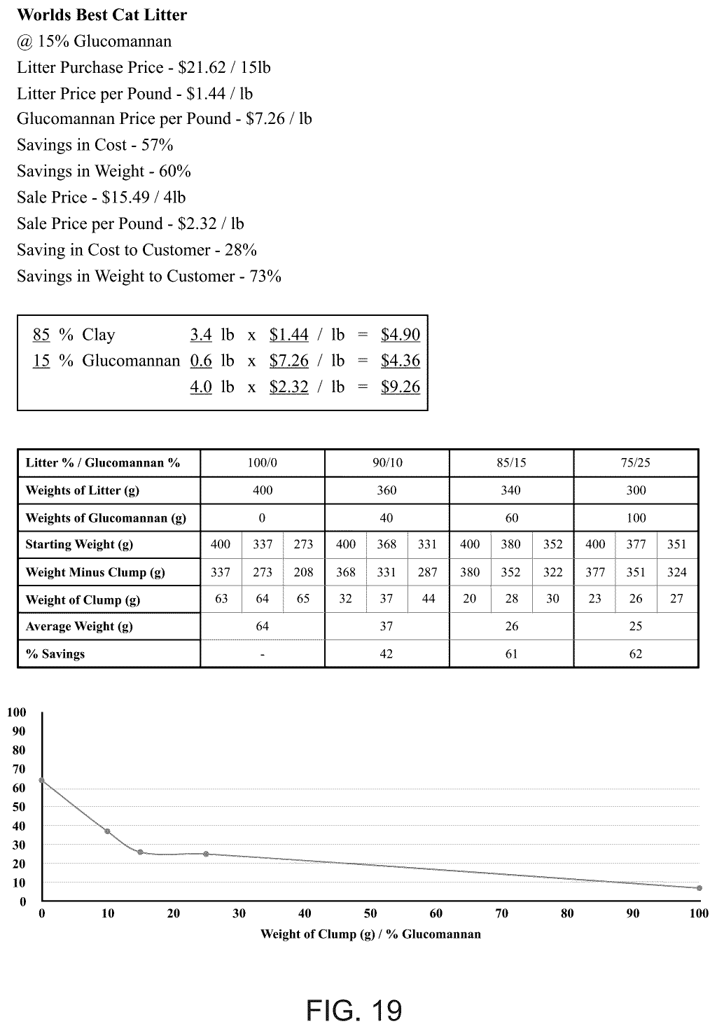

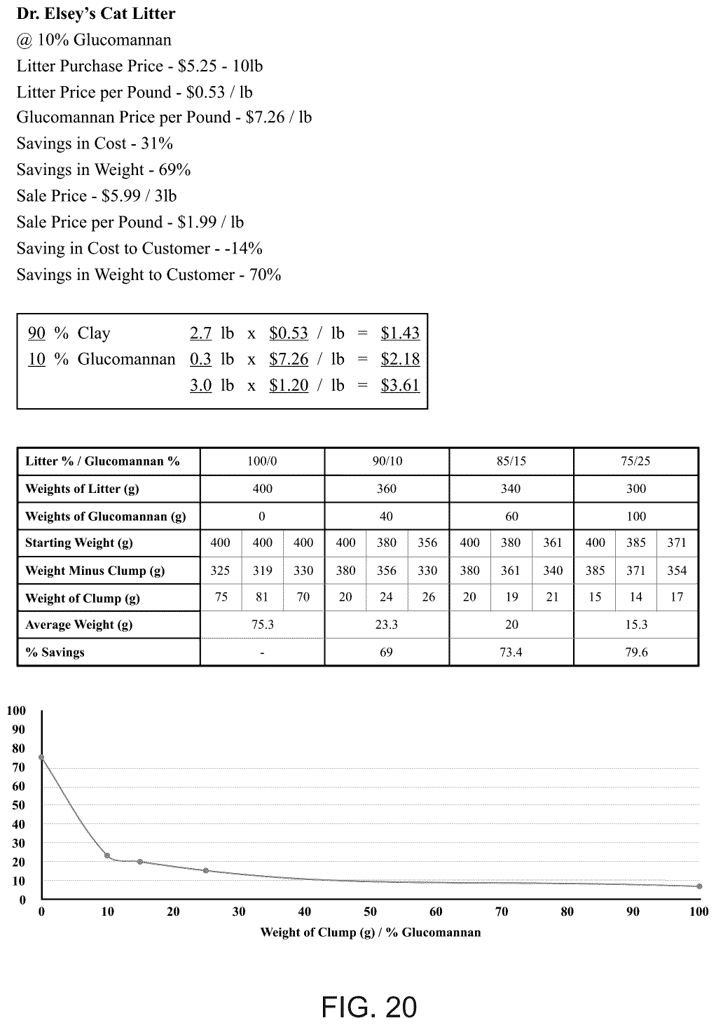

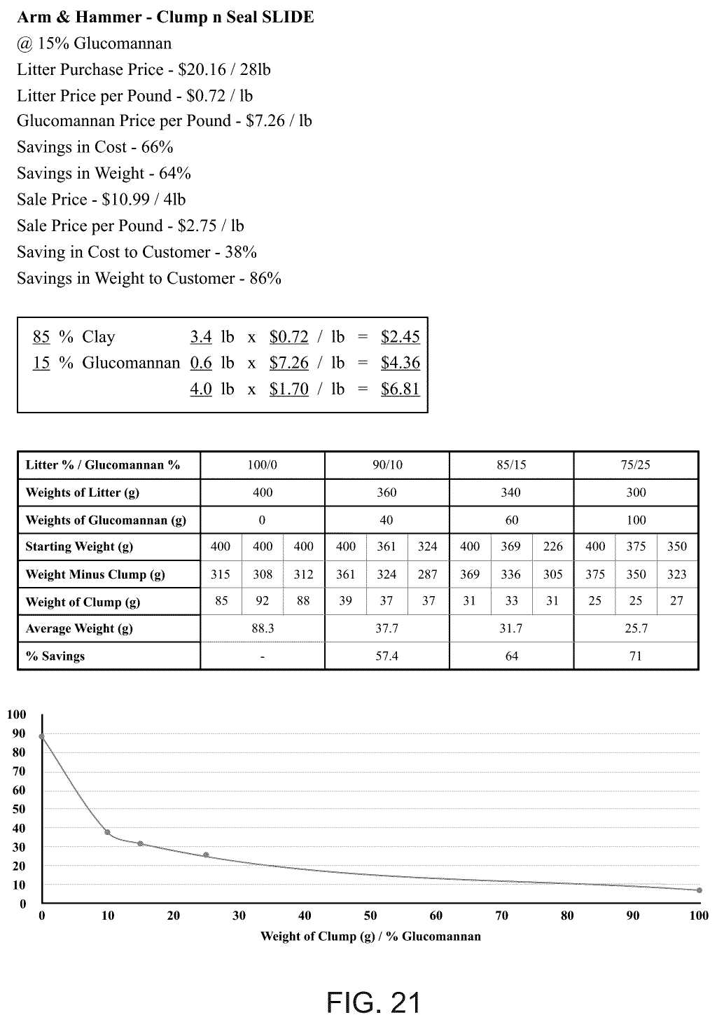

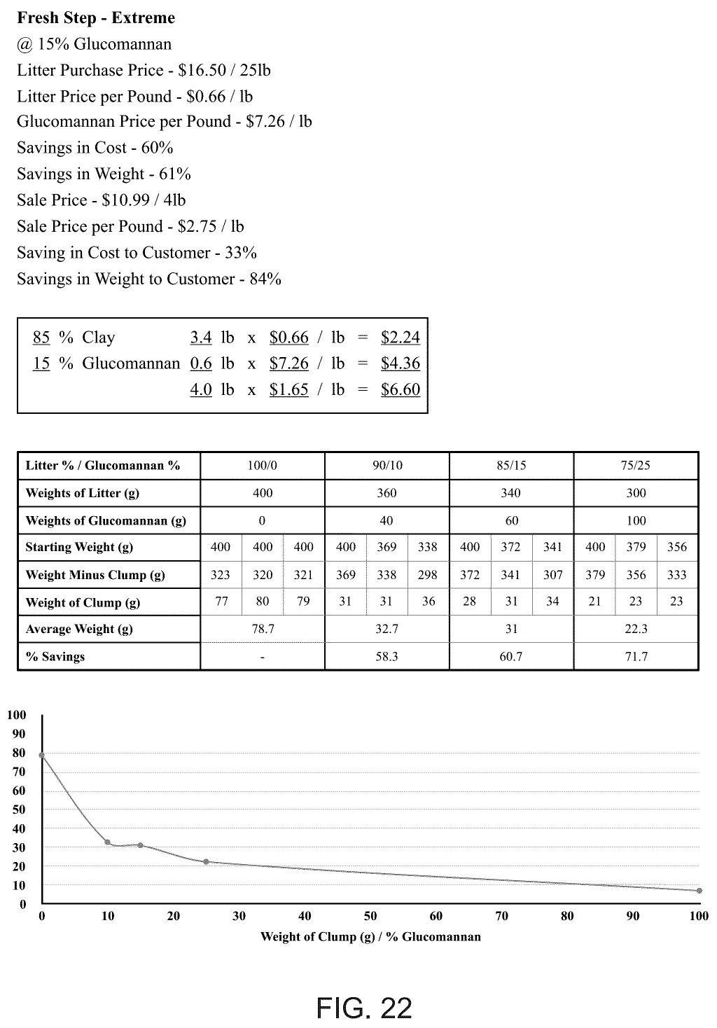

The data was collected in a manner consistent with previous experiments, and is outlined in FIGS. 18-22.

Glucomannan alone, when immersed in water creates a gel-like substance trapping many times its mass in water, making it desirable as an additive for clumping cat litter. It is a common practice in the culinary industry to mix glucomannan with a strong alkaline additive in water to create a thermally stable gel which when sliced is known as a “shirataki noodle.” This process allows the noodles to be cooked or served in soups without the gel breaking down, even at high temperatures. It was surmised that this quality may be desirable in a cat litter as well, on the theory that an existing clump in a litter box would be less likely to break down if was to come into contact with fresh urine.

Several experiments were conducted where potassium carbonate and calcium hydroxide were added dry to the glucomannan at a ratio of 4:1 and 12:1 respectively, these ratios being obtained from the culinary industry as an accepted ratio in recipes. These additives were mixed first with the glucomannan, then with the base litter. The effect of the strong alkaline additives is to raise the pH of the solution, thusly facilitating acetyl group formation. The adverse effect of this catalyzed reaction is that the formation of these acetyl groups increases the hydrophobicity of the glucose chains. This reaction manifested itself in the experiment as a much firmer and more stable clump, although one weighing about 30% more than a glucomannan litter clump without the additive. This experiment has raised the question of whether a lower pH would increase the absorbability of glucose in an opposite reaction.

As glucomannan is made up of rather long hemicellulose chains, the size of particles found in konjac roots varies wildly from 2 μm to 1 mm, with an industry standard aimed at around 125 μm-335 μm for most applications. Much research has been conducted regarding the length of time that various sized glucomannan particles require to reach their maximum hydration level, as it is commonly used as a suspension and delivery agent for certain medications. This can be easily measured with a viscometer by monitoring where the curve of a graph levels off as the glucomannan in solution will reach its maximum viscosity at the same point that it reaches its maximum hydration. These hydration times vary from 8 minutes at 132 μm to 90 minutes at 452 μm, suggesting that a smaller particle size allows water molecules to come into contact with the glucose chains more quickly. While a smaller glucomannan particle size provides the benefit of faster clumping in a cat litter application, it also creates the issues of added ambient dust, as well as staying mixed with the base litter during shipping. Through the conducting of the purity experiments, it was observed that glucomannan could be suspended in a solution containing a mixture of water and ethanol. It was theorized that a paste could be formed by mixing glucomannan with ethanol and allowing the solvent to be purged with heat and pressure to create a sheet of glucomannan that could be broken up into larger particles made up of smaller granules roughly equal in size to the average clay particles in conventional cat litter, generally 50 μm-2 mm. This method proved successful, though the dry clumps of glucomannan ranged in size from ½ to several millimeters, the absorption time was still equal to that of the ˜150 μm particle size, with the added benefit of reducing dust and staying suspended within the base litter far better than the smaller particles.

Exemplary particle sizes for glucomannan according to the described embodiments range from 1 μm-2 mm, preferably 50 μm-0.3 mm, or more preferably 50-150 μm. Particle sizes above 150 μm tend to increase absorption time, and particle sizes below 50 μm tend to create too much ambient dust in use.

According to another exemplary feature of the described embodiments, absorption performance of the glucomannan mixture was improved by subjecting the glucomannan to heat prior to mixing. The material was spread on a tray and placed in a heat source at 175 degrees F. with the heat source door slightly ajar. After mixing with suitable additives, the amount of product required to absorb 40 grams of water was reduced from about 7 g of glucomannan to about 4 g of glucomannan, resulting in over 33 percent savings. It was assumed that the exposing the glucomannan to heat dried the material thereby enabling the material to absorb more water.

The product is described as a box, bag or parcel containing glucomannan of a 90% purity, possibly containing one or more of the aforementioned additives, and/or having undergone one or more of the processes described above. The product would be intended for use as an additive to any medium, or existing brand of cat litter of the customer's choice.

The product is described as a packaged cat litter containing a clay or organic substance as the base medium, with some percentage of glucomannan of a 90% purity, possibly containing one or more of the aforementioned additives, and/or having undergone one or more of the processes described above. The product would be intended for use as a direct replacement for existing cat litter applications.

In an exemplary application, the product may be used as a packaged cat litter intended for use in modern self-cleaning litter robots. An exemplary litter robot is described in U.S. Patent Publication 2024/0206422, the contents of which are hereby incorporated by reference. A rotating cavity rotates from an initial position in a first direction, a second opening is opened, and cat litter containing cat excrement is loaded into a screen. Cat excrement is discharged by the screen through the second opening, and cat litter is screened out. The rotatable cavity rotates in the direction opposite to the first direction, the screened cat litter is returned, and the second opening is closed at the same time.

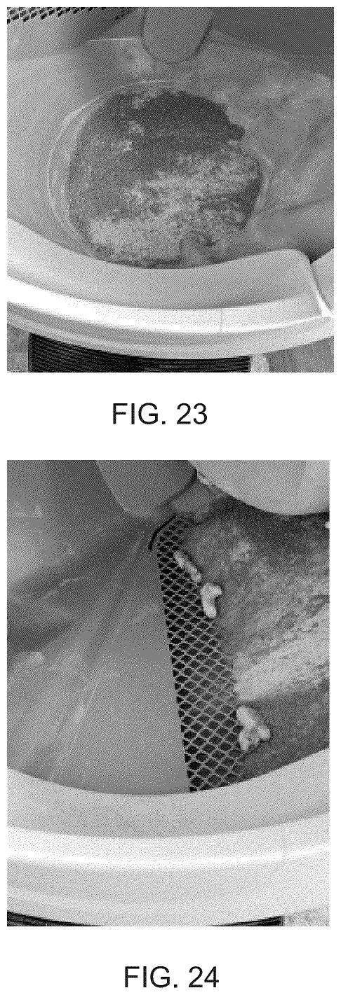

A mixture may be used containing a clay or organic substance as the base medium, with some percentage of glucomannan of a 90% purity, possibly containing one or more of the aforementioned additives, and/or having undergone one or more of the processes described above. The product would be intended for use as a direct replacement for existing self-cleaning litter robots, providing cost and weight savings, as well as reducing CO₂ and O₂ emissions associated with the mining and processing of bentonite clay. With reference to FIGS. 23-25, the product provides superior clumping when used with clay or organic litters, reducing crumbles, dirty litter and odor while ensuring a cleaner lining and better function of litter robot products.

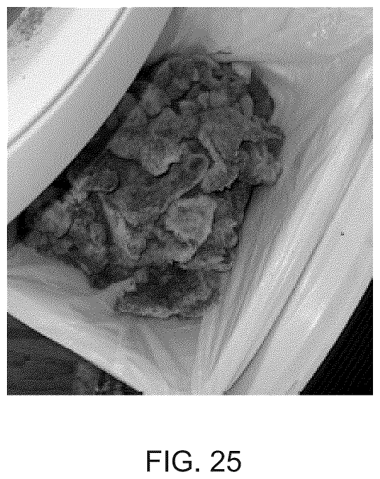

FIG. 23 shows the glucomannan mixture in the rotating cavity. A thin layer of the glucomannan coats the inside lining, which prevents sticking. FIG. 24 shows feces clumps completely coated in the mixture. The glucomannan prevents sticking and also reduces odor. Conventional litter results in unstable clumps with material that sticks to the sides of the lining. FIG. 25 shows the collection bin of the litter robot with glucomannan mixed in the cat litter. The clumps are smaller, tighter, almost rubbery, and with little odor.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An absorbent material comprising:
1-99% by weight glucomannan having a known purity; and
at least one of biodegradable and non-biodegradable additives.

2. A material according to claim 1, wherein the known purity of the glucomannan is less than 100%.

3. A material according to claim 2, wherein the known purity is 1-99%.

4. A material according to claim 3, wherein the known purity is 75-99%.

5. A material according to claim 4, wherein the known purity is 75-90%.

6. A material according to claim 4, wherein the known purity is one of 75% and 90%.

7. A material according to claim 6, wherein the known purity is 75%.

8. A material according to claim 1, comprising 5-25% by weight of the glucomannan and 75-95% by weight of the biodegradable additives.

9. A material according to claim 1, wherein the biodegradable and non-biodegradable additives are selected from clay or bentonite.

10. A material according to claim 1, wherein the biodegradable and non-biodegradable additives comprise commercially available cat litter.

11. A material according to claim 1, wherein the biodegradable and non-biodegradable additives comprise commercially available clumping and non-clumping silica cat litter.

12. A material according to claim 1, wherein the biodegradable and non-biodegradable additives comprise commercially available organic cat litter.

13. A material according to claim 1, wherein a particle size of the glucomannan ranges from 1 μm-2 mm.

14. A material according to claim 13, wherein the particle size of the glucomannan ranges from 50 μm-0.3 mm.

15. A material according to claim 13, wherein the particle size of the glucomannan ranges from 50-150 μm.

16. Cat litter comprising:
a base material that is organic or inorganic; and
1-99% by weight glucomannan of a known purity.

17. Cat litter according to claim 16, wherein the known purity of the glucomannan is less than 100%.

18. Cat litter according to claim 17, wherein the known purity is 1-99%.

19. Cat litter according to claim 18, wherein the known purity is 75-99%.

20. Cat litter according to claim 19, wherein the known purity is 75-90%.

21. Cat litter according to claim 20, wherein the known purity is one of 75% and 90%.

22. Cat litter according to claim 21, wherein the known purity is 75%.

23. A litter robot including a rotating cavity and the cat litter of claim 16 disposed in the rotating cavity.

24. A method of manufacturing a composition for absorbing fluids, the method comprising mixing a base material that is organic or inorganic with 1-99% by weight glucomannan of a known purity.

25. A method according to claim 24, further comprising, prior to the mixing step, heating the glucomannan.

26. A method according to claim 25, wherein the mixing step comprises mixing the base material with 1-99% glucomannan with the known purity is 75-90%.
